(19) United States
(12) Patent Application Publication
(10) Pub. No.: US 2015/0235249 A1
(43) Pub. Date: Aug. 20, 2015

(54) SYSTEMS AND METHODS FOR TRACKING VALUE

(71) Applicant: Red Truck Group, Inc., Portland, OR (US)

(72) Inventor: John D. Wrenn, Portland, OR (US)

(21) Appl. No.: 14/626,824

(22) Filed: Feb. 19, 2015

Related U.S. Application Data
(60) Provisional application No. 61/941,965, filed on Feb. 19, 2014.

(51) Int. Cl. G06Q 30/02

(52) U.S. Cl. CPC G06Q 30/0206

(57) ABSTRACT

Methods and systems are provided for tracking one or more items purchased by a user, automatically estimating current transition price of the items and tracking a market transition value of the items over time.

### CROSS REFERENCE TO RELATED APPLICATIONS

This application claims the benefit of U.S. Provisional Patent Application No. 61/941,965, filed Feb. 19, 2014 entitled, “Systems and Methods for Tracking Value,” which is hereby incorporated for reference in its entirety for all purposes.

### FIELD

The present disclosure relates generally to systems and methods for maintaining a record of purchased items and tracking a value of the purchased items.

### BACKGROUND AND SUMMARY

On-line shopping services facilitate transactions that enable individual users to purchase new goods from a merchant. Users may have an older model of an item that has significant value but may want to purchase a newer version and sell the older model. For example, outdoor sporting goods may become outdated as styles change and products improve over time. Therefore, sport enthusiasts may desire to purchase newer models of outdoor gear. However, the older models may still be functional and have re-sale value.

In current systems, significant time and effort may be required to track the purchase, and estimate the value of used goods at the time of re-selling, donating, and filing for insurance claims. Further, lost or stolen items may be difficult to recover without a good record of ownership. Still further, finding used or after-market items for sale and selling the items quickly for a fair price may be difficult.

Certain online services provide tools for selling and buying new and used items. However, these services are limited in that the user generally posts a resale price based on their own research. The user may have to independently track potential items for resale and research and track potential fair value for the market for the used items. For example, deal-of-the-day and other group buying web sites may offer products at discounted prices for a limited period of time to users who subscribe to these services. Further, some advertisers offer local coupons to users of location-aware devices (e.g. global position systems and devices) that are detected within a target region. However, even when products and services are offered in bundles, offered to a subscriber group, and/or offered based on location, these offers may be priced just beyond a potential buyer's willingness to pay. The offer price is typically fixed until the product is sold. In other example, if the product is not sold, within a given time period, the seller may adjust the price downward to encourage sales.

In these systems, the manual adjustment of price is based on whether or not the product was sold at the marketplace portal. The seller does not have a method of determining the value of items. Further, the seller does not have a method of communicating with particular buyers, for example, to learn that a buyer may be willing to pay just a little less than the current asking price for a product, or travel a bit further to pick up a less expensive product. Lacking this knowledge, willing buyers and willing sellers may miss opportunities to consummate sales that would be of mutual benefit.

Additionally, some attempts have been made to provide model an item's depreciation. For instance, the price of a used item may be calculated based on linear depreciation. However, modeling a used items price based linear depreciation over simplifies a products value and may not provide an accurate price for a used item.

The inventors have identified the above mentioned disadvantages and provide systems and methods for storing information regarding purchased items, pricing, and tracking values of items for sale that may benefit merchants, brands and consumers. As described in more detail below, the inventors herein disclose systems and methods for tracking value of used items. In one example, the inventors have recognized the need for a method for maintaining a record of purchased personal items and for automatically generating a transition value for the used items over time based on a number of market factors gathered via a different Internet sources. These market factors can include a specification factor, an available inventory factor, and/or asocial trend factor of a used item. In this way, the transition value of a used item can be quickly and accurately determined in an unconventional manner using a large number of factors which have not been previously used in value estimation of used items. Moreover, this large amount of information can be quickly gathered from disparate sources through techniques that were not formerly available. The large amount of data can then be processed in a unique way to provide a more accurate transition value. The improved pricing method enables a user to quickly be provided with an accurate price of an item, enabling the owner of the used item to make a number of determinations about the item such as a desire to resell the item, insurance claims regarding the item, etc.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE FIGURES

FIG. 1 schematically shows an overview of an online garage system, including a client computing device, a garage server, and one or more servers that communicate with the garage server according to one embodiment of the disclosure.

FIG. 2 schematically shows an overview of a pricing engine utilized by the online garage system of FIG. 1 to determine a value of a product and track the value of the product over a period of time.

FIG. 3 schematically shows an overview of functions of a pricing engine in the garage system of FIG. 1 including determination of instant product value and product value over a product lifecycle.

FIG. 4 shows a flow chart illustrating an example method for determining a value of a product in the online garage of FIG. 1 by utilizing the pricing engine of FIG. 3.

FIG. 5 shows a flow chart illustrating an example method for obtaining price and specification information of a product in the online garage system of FIG. 1 to determine the value of the product.

FIG. 6 shows a flow chart illustrating an example method for determining value of a product based on price and specification information obtained by the method of FIG. 5, vertical listings, and current product condition.

FIG. 7 shows a flow chart illustrating an example method for determining value of a product based on one or more factors including social, seasonal, and climatic factors.

FIG. 8 shows an example block diagram illustrating one or more components of the pricing engine of FIG. 4.

FIG. 9 schematically shows an overview illustrating example interactions of the pricing engine of FIG. 4.

FIG. 10 shows a high level flow chart illustrating an example method for tracking value of a product.

FIG. 11 shows an exemplary graphical user interface of a search function of the online garage system of FIG. 1.

FIG. 12 shows an exemplary graphical user interface of an output of the online garage system of FIG. 1.

FIG. 13 shows an exemplary graphical user interface representation of determination of value of a product.

FIG. 14 shows an exemplary graphical user interface of a product value output of the pricing system of FIG. 1.

FIG. 15 shows a method for automatically pricing a used item.

### DETAILED DESCRIPTION

A system and method for determining a transition value of used items using market factors gathered via the Internet. The market factors can include a specification factor, an available inventory factor, a social trend factor, and/or a climatic factor of a used item. In this way, many different data sets gathered via the Internet can be leveraged to provide an accurate value estimation algorithm of a used item in an unconventional manner that was not previously available. Determining a price of a used item in this unconventional way enables the accuracy of the transition price to be improved. Moreover, it will be appreciated that this system can be easily applied to a wide variety of goods which was not previously possible using prior techniques that are specialized for particular types of goods, such as vehicles. That is to say that the pricing engine inputs can be standardized across different goods, to increase the applicability of the pricing method to a greater number of used items. Increasing the applicability of the system enables the system to appeal to a broad range of consumers.

Aspects of this disclosure will now be described by example and with reference to the illustrated embodiments. Components and other elements that may be substantially the same in one or more embodiments are identified coordinately and are described with minimal repetition. It will be noted, however, that elements identified coordinately may also differ to some degree. It will be further noted that the drawings included herein are schematic and generally not drawn to scale. Rather, the various drawing scales, aspect ratios, and numbers of components shown in the figures may be purposely distorted to make certain features or relationships easier to see. Therefore, the figures are not intended to be technically precise, but are drawn to ease understanding.

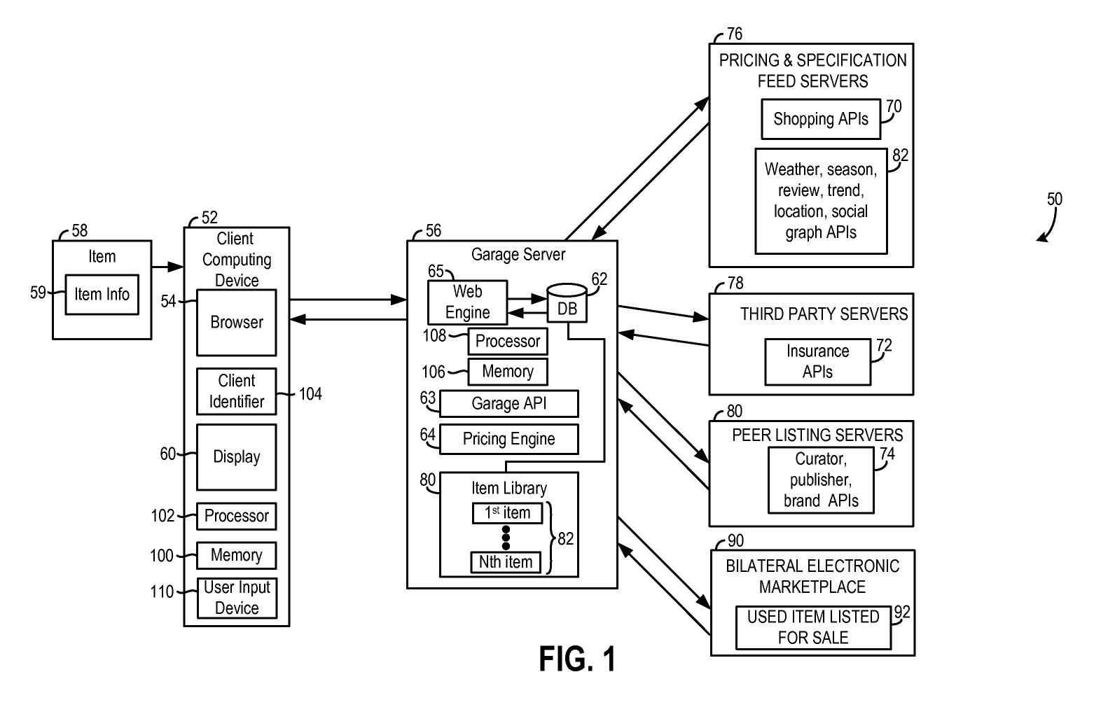

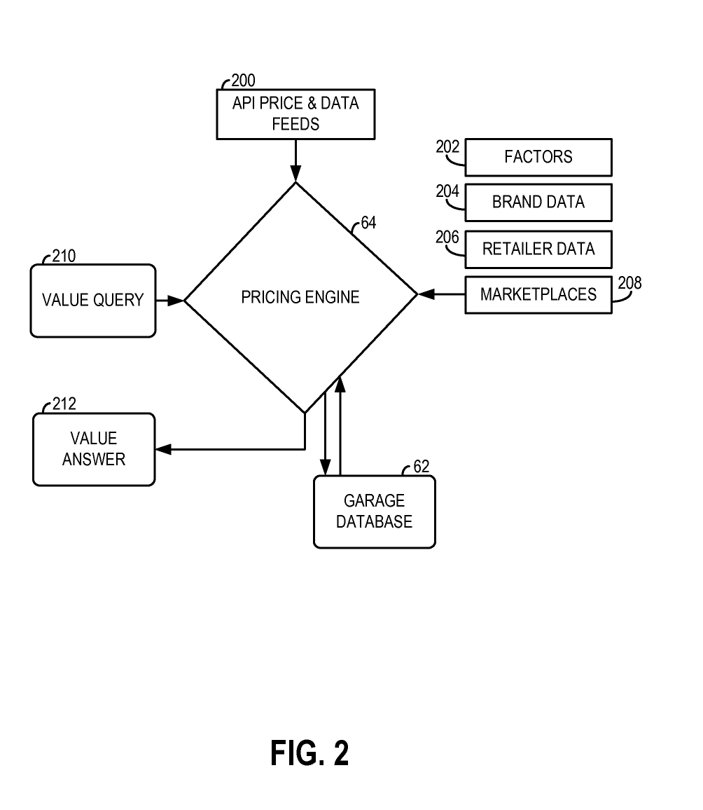

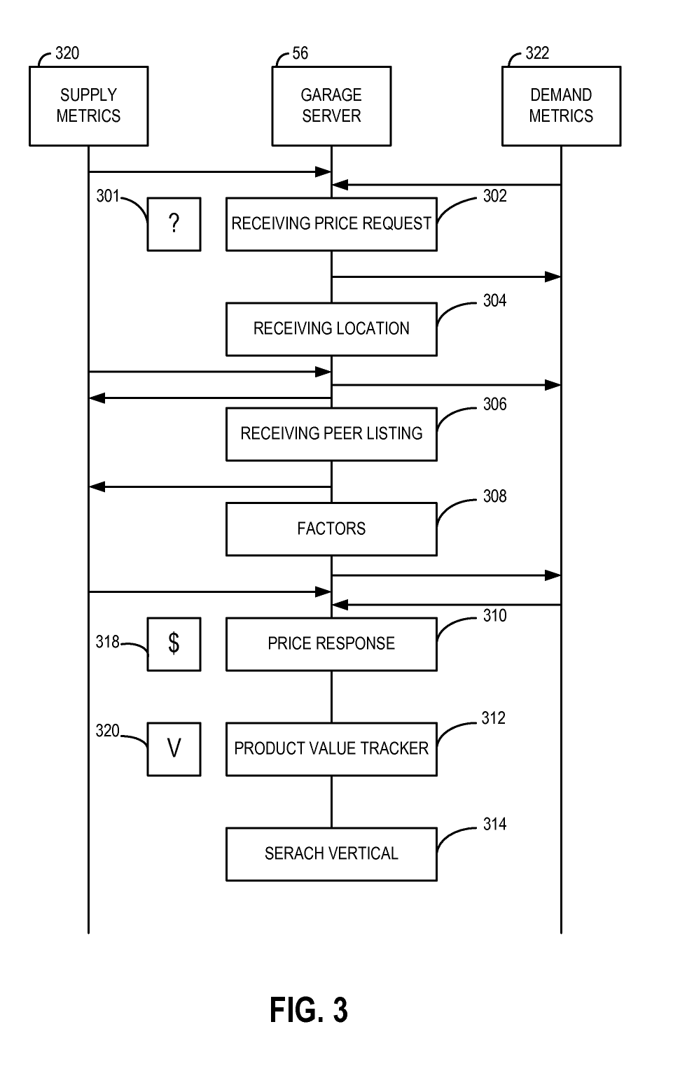

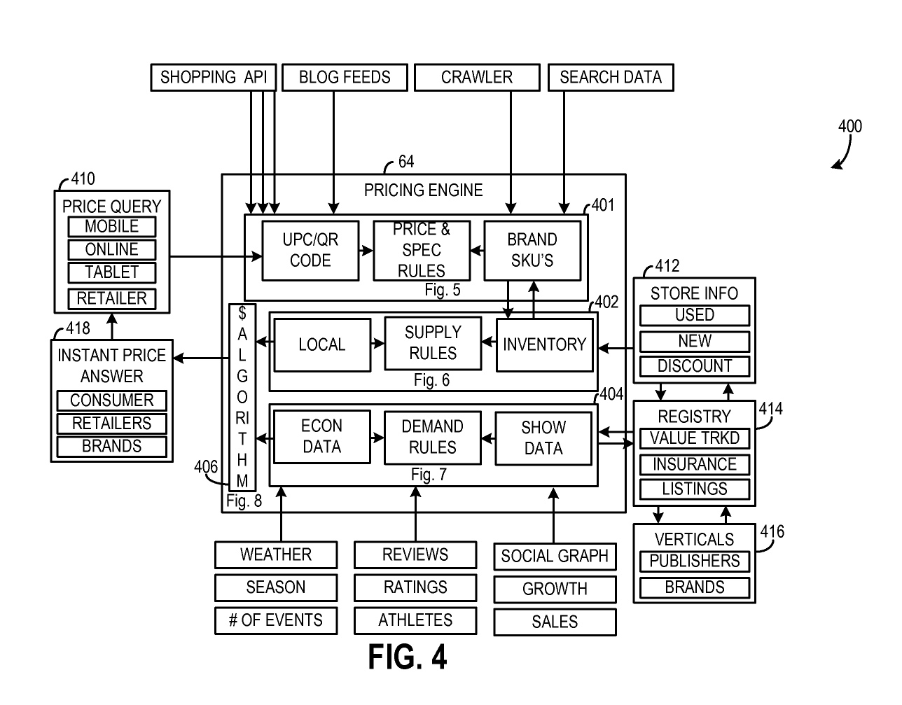

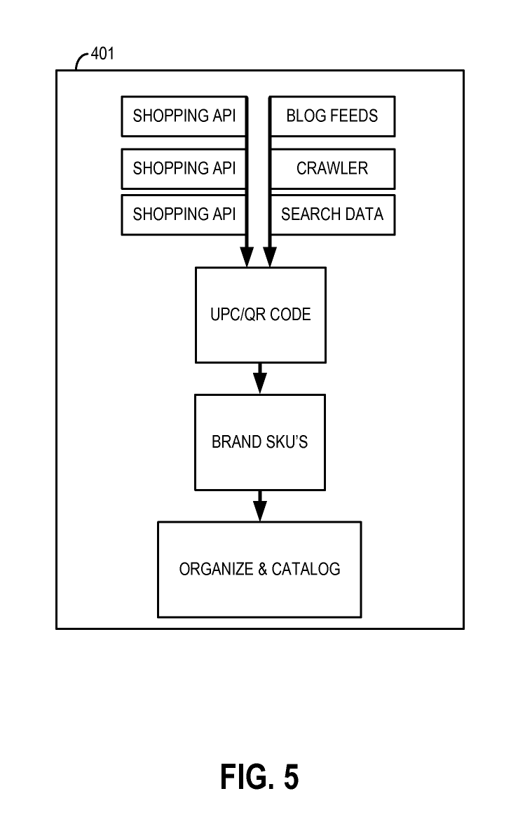

Embodiments are disclosed herein relating to maintaining a record of one or more items of purchase, pricing and tracking the value of items in an online garage system, such as the system of FIG. 1. An overview of a pricing engine utilized to estimate the value of items in the online garage system of FIG. 1 is schematically shown at FIG. 2 and an overview of components involved in determination of the value of items is schematically shown at FIG. 3. A method for determining the values of items in the online garage system utilizing the pricing engine is illustrated at FIG. 4. Methods for determination of each component of the pricing engine are shown at FIGS. 5-8. As described in more detail below, the methods and systems for tracking value over time may include methods and systems for tracking market transition value of a used or purchased good for use in resale, purchase, filing insurance claims and tracking of the lifecycle value of the purchased good.

An example online garage system 50 is shown in FIG. 1. The online garage system 50 may enable a user to track market transition value of purchases through a number of methods, including, but not limited to, storing purchase information of one or more items purchased by the user of the garage system, estimating the value of the items purchased at any given time, and tracking the value of one or more items over a period of time.

In one example, the user may access the online garage from a client computing device 52 such as a mobile, a tablet, or a personal computer via a network, such as a public network, a private network or other network. In some embodiments, the computing device may be coupled through the internet, through a browser 54 or other similar system. The browser 54 may interact with a garage server 56 to obtain information requested by the user such as search and value information.

The internet includes a vast number of computers and computer networks that are interconnected through communication links. The interconnected computers exchange information using various services, such as electronic mail and the World Wide Web (WWW). The WWW service allows a garage server 56 to send graphical web pages of information to the client computing device 52. The garage server 56 therefore may be configured to host a website. The client computing device 52 may then display the web pages on a display 60. Each resource (e.g., computer or web page) of the WWW is uniquely identifiable by a Uniform Resource Locator (URL). To view a specific web page, the client computer system may specify the URL for the web page in a request (that is, a Hyper Text Transfer Protocol (HTTP) request). The request can then be forwarded to the web server that supports the web page. When the web server receives the request, it sends the web page to the client computer system. When the client computer system receives the web page, it typically displays the web page using the browser.

The client computing device 52 also includes a user input device 110 (e.g., a mouse, trackpad, keyboard, touchscreen, touch-pad, combinations thereof, etc.). Thus, a user can input various data into the client computing device 52 and specifically graphical user interfaces generated via the client computing device.

Therefore, it will be appreciated that the garage server 56 and the client computing device 52 may communication over a network such as the internet and/or other suitable networks.

As shown, the client computing device 52 is configured to run a browser 54. The browser 54 may be a special-purpose application program that effects the requesting of web pages and the displaying of web pages. However, numerous suitable network browsers have been contemplated. Currently, web pages are typically defined using Hyper Text Markup Language (HTML). HTML provides a standard set of tags that define how a web page may be displayed. When a user requests the browser to display a web page, the browser sends a request to the server computer system to transfer to the client computer system an HTML document that defines the web page. When the requested HTML document is received by the client computer system, the browser displays the web page as defined by the HTML document. The HTML document contains various tags that control the displaying of text, graphics, controls, and other features. The HTML document may contain URLs of other web pages available on the server computer system or other server computer systems.

Electronic commerce (e-commerce) may be conducted through the WWW. Many web servers have been developed through which vendors can advertise and sell products. The products may include items (ski goggles, for example) that are delivered through conventional distribution channels (a common carrier, for example). A server computer system may provide an electronic version of a catalog that lists the items that are available. A user, who purchased an item is often emailed a receipt when the user has completed the purchasing the item. The server computer system may send the user information that is purchaser-specific and may include personal purchase identification information, such as, the purchaser's name, the purchaser's last four digits of credit card number, and a shipping address for the order and unique product ID. Thus, as shown the item 58 can be purchased via the client computing device 52. However, in other examples, a user can purchase a product at a brick and mortar retailer. The item 58 includes item information 59. It will be appreciated that after the item is purchased and used the item is referred to as a used item. The item information 59 may include an items name, year produced, brand, size, etc. The item information may also include unique identifiers such as universal product code (UPC), a quick response (QR) code, and/or a brand stock keeping unit (SKU). Still further in some examples, the item information may be entered into the client computing device 52 via a graphical user interface. In other examples, the item information may be gathered via 3^{rd} party servers. Still further in some examples, a portion of the item information may be entered by the user and a portion of the item information may be automatically gathered via 3^{rd} party server.

Exemplary items may include, but are not limited to, sporting goods including skis, snow boards, wearable sports devices, wearable fitness devices, wearable monitoring devices, bikes, surf boards, shoes, kayaks, canoes, football, volleyball, basketball, and other sporting goods. The sporting goods may include outdoor and indoor sporting goods. In some other examples, the used items may include goods for electronic consumer goods, photography goods, goods for art work, art works, goods for baby, goods for home and office, antique goods and any other resellable/tradeable or donatable good. The used items may have a re-sale value, a trade-in value, and/or a donation value.

In one example, the garage system 50 may be utilized to store and maintain a record of information of items purchased by the user. The items may be purchased online or in-store at a local retailer. In one example, the online garage system may be utilized to search for items for sale by other users of the garage system, and/or retailers. In some examples, one or more items from the search may be purchased from an e-commerce business such as eBay, Amazon, or any e-commerce retailer through the online garage system. In some examples, items may be purchased from another garage user through the online garage system.

When the online garage system 50 is utilized for purchase, information regarding the items purchased may be stored in a garage database 62. In one example, the online garage system 50 may interact with an e-commerce business database to obtain information regarding the items purchased, and store the information in the garage database. Additionally or alternatively, the user may manually enter information regarding the item purchased in the online garage system. Information regarding items purchased in-store may also be entered manually in the online garage system by the user. In this way, the online garage system may be utilized to maintain a record of information of items purchased by the garage user. The information stored may include, but is not limited to, item name, Universal Product Codes (UPC)/Quick Response (QR) codes, brand Stock Keeping Units (SKUs), date and time of purchase, cost, and purchase location. Additionally, the information stored may include warranty information, if any. The garage database 62 may include at least one item library 80 associated with the client computing device 52 and including a plurality of items 82. The plurality of items 82 can include the aforementioned item data. The item data can also include a geographical location of the item and/or market factors that may include a specification factor, an available inventory factor, and/or social trend factor of the used item. These factors may be numerically represented to indicate a trend or difference over time. It will be appreciated that in other examples at least a portion of the garage database 62 and/or item library 80 may be included client computing device 52.

In addition to storing purchase information, the garage server 56 may be utilized to estimate the value of one or more items of interest at any given time, track the value of one or more items of interest over a period of time, and sell one or more items in the garage database 62. Still further, the garage server 56 may be utilized as a portal for vertical market. For example, publishers and brand marketers may advertise items that may be of interest to the garage user.

In one embodiment, the garage server 56 may automatically generate a market transition value for one or more items stored in the garage database 62. For example, upon opening the online garage interface, a list of items stored by the user and an estimated value for each item may be automatically available to the user via the client computing device 52. Additionally, a market transition value over time for each item may be automatically available to the user. The estimated value and the market transition value may be updated every time the user logs in to the online garage system 50. A tracking system may store and present prior market transition values based on preselected time periods, user-selected check-in periods, or other selected or preselected timelines.

The garage system 50 and specifically the garage server 56 may include a pricing engine 64 for estimating the value of an item in the garage database 62. An overview of a function of the pricing engine 64 is shown at FIG. 2. In one example, the pricing engine may be an algorithmic pricing engine. Upon receiving a query for estimating the value of an item, the pricing engine 64 may estimate a value for the queried item based on pricing and specification information from one or more sources such as eBay, Amazon, Square etc. and calculate a value for the queried item. The pricing engine may interact with an Application Protocol Interface (API) (70, 72, and 74) of servers (76, 78, and 80) of the one or more sources to collect information from the source database. The value of the item may be further based on factors as described at FIGS. 3-4. Upon collecting information regarding the queried item, the pricing engine 64 may estimate a value of the queried item. In one example, all calculations for estimating value may be performed by the pricing engine at the garage server 56. In another example, additional calculations may be performed by the client computing device 52 via the browser 54. It will be appreciated that gathering data from the aforementioned servers enables a large amount of data to be gathered and subsequently used in a novel and unconventional manner to quickly provide a user with a more accurate price via a technique that was not previously possible.

The servers 76 are pricing and specification feed servers including shopping APIs 70 and weather, season, review, trend, location, social graph APIs 82. Additionally, the servers 78 are third party servers which include insurance APIs 72. Furthermore, the servers 80 are peer listing servers that include curator, publisher, brand APIs 74. It will be appreciated that the servers (76, 78, and 80) can provide the garage server with various types of data which can be used as inputs into the pricing engine 64. It should further be appreciated that the servers, in some embodiments, may be or include specific pricing engines, season and review engines, trend engines, specification engines, insurance engines, publisher engines, etc.

The online garage system 50 may further include a bilateral electronic marketplace 90 in communication with the garage server 56. The bilateral electronic marketplace 90 includes a plurality of used items listed for sale 92. The used items listed for sale may correspond to used items in the item library 80.

As shown, the garage server includes a garage API 63 and a web engine 65. The web engine 65 may be configured to provide various network connection capabilities to the garage server 56. Thus, the web engine 65 may be configured to enable access of the pricing engine over a network, such as the Internet. Additionally, the garage API 63 may be configured to implement various pricing functionalities which are discussed in greater detail herein.

The client computing device 52 includes memory 100 executable via a processor 102. Code may be stored in the memory 100 to implement the various methods, techniques, etc., associated with the client computing device 52 discussed herein. The client computing device 52 can also include a client identifier 104. The client identifier 104 may be used by the garage server 56 to determine the user's item library.

The garage server 56 also includes memory 106 executable via a processor 108. Again code may be stored in the memory 106 to implement the various methods, techniques, etc., associated with the garage server 56 discussed herein.

In one additional example, the client computing device 52 may be configured to provide an interface for a user to input purchase information of an item, and request a value for the item. Continuing with the example, the garage server 56 may be configured receive the input purchase information and process the input purchase information and automatically track a market transition value of the item over time based on a geographical location of the used item and market factors including one or more of a specification factor, an available inventory factor, and a social trend factor of the used item. In such an example, the garage server 56 may also be configured to determine a transition price of the item based on the market transition value and send an output including the transition price and the market transition value over time to the client computing device 52. Additionally, in such an example, the database 62 may be configured to store information regarding the user, the used item, the transition price, and the market transition value of the item.

Additionally, the pricing engine 64 may receive multi-channel product feeds such as from online auction databases and/or online retailer databases through the sites respective API's, such at the APIs (70, 74, 76, and/or 82). Additionally, curator community listings may feed into pricing database. The pricing engine may extract data from brands, retailers & consumers listings to obtain pricing information and product specification. The pricing engine may compare items old & new for sale to estimate value. In determining the value of items, the pricing engine can account for weather & sport seasonality, social graph trends, location to determine relationship of price to buyer & seller, POS data. Further, the pricing engine may crawl & score search ranking and blog feeds for popularity of item.

Further, the pricing engine 64 may be configured to track number of events & growth of sport, accounts for brands connected to vertical, catalogs SKU's & Unique ID's through feeds. Still further, the pricing engine may be configured to package listing details including suggested price for publishing in marketplaces and provides product authentication through social and brand connections.

Value of each item may be tracked individually or values of items in a group may be tracked at any given time point. Further, the online garage system 50 may be utilized to track value of one or more items of interest over a period of time.

In another example, the user may use the value information to make decisions regarding selling one or more items. By continuously tracking value of items of interest, the user may make a decision to sell an item without incurring great loss. When the user makes a decision to sell an item, the user may click a “list item for sale” button in the online garage interface. Upon clicking the “list item for sale” button, the user may be provided with one or more options including listing the item for sale in a garage market-place, which may be a part of the online garage system 50, listing item for sale in an e-commerce business site, and listing item for sale in one or more bilateral market places. The user may then select either one or more options to list the item for sale. Upon selecting the listing options, the garage system may automatically post the items for sale.

Further, based on the items listed for sale, the garage system 50 may provide the user with recommendations for new items to buy. For example, if the user lists an older model for sale, the garage system may search one or more databases for a newer model of the item listed for sale and provide recommendations to the user based on the search. In addition, curators and publishers may utilize the listing information to post advertisements for products that may be of potential interest to the user. In still another example, the user may search the online garage system to buy one or more items of interest depending on the value of the items.

In this way, the online garage system 50 may be utilized to list, share, buy & sell gear to any store. By utilizing the online garage system 50 one or more items may be aggregated and tracked through re-commerce market places, shopping platforms, and payment processor APIs. The items may be purchased through mobile point of sale (MPOS), mobile payments, digital payments, or embedded payment solutions. Further, the items may be stored in the user's registry making it simple to find lost or stolen items, provide insurance documentation, find parts, modify items, schedule repairs, and value items instantly over the useful life of the item. Taken together, the online garage system may be utilized to make better decisions about selling and buying. Furthermore, the online garage system enables various disparate data sets from used item information sources to be gathered in a novel way to enable a transition value of a used product to be accurately determined using a new algorithm which takes into account all the different data sets.

FIG. 2 shows an illustration of the inputs and outputs which may be associated with the pricing engine 64, shown in FIG. 1. As illustrated, the pricing engine 64 may receive API price and data feeds 200 from servers, such as the servers (70, 72, and 74), shown in FIG. 1. Additionally, the pricing engine 64 can also receive factors 202, brand data 204, retailer data 206, and marketplaces 208. In this way, the pricing engine 64 can use a large amount of data to improve the accuracy of a transition value determined via the engine. Additionally, the pricing engine 64 can send data to and receive data from the garage database 62.

The pricing engine 64 is shown receiving a value query 210 from a client computing device such as the client computing device 52, shown in FIG. 1. It will be appreciated that a value query is configured to ask for a transition price and/or a market transition value of a used item. In response to receiving the value query the pricing engine 64 is configured to return a value answer 212 to the client computing device. The value answer can include transition price and/or a market transition value of the used item. It will be appreciated that the value query may be generated via a single action in an interface, such as clicking on a button.

Turning to FIG. 3, it shows various factors that a pricing engine, such as the pricing engine 64 shown in FIGS. 1 and 2, may take into account in order to estimate the value of an item in the garage system and track the value of the item during its lifecycle. The pricing engine in the garage server 56 can receive supply metrics 320 and/or demand metrics 322 at various points in the process flow shown in FIG. 3.

The pricing engine may receive a request (301) from a user through an interface of the client computing device such as a browser for estimation of a value of an item (302). The pricing engine may estimate value of the item based on location (at 304), peer listing (at 306), and additional factors (at 308). The location may be determined from a point of sale (POS) such as mobile, tablet, computer, or retail shop. The data from POS may include information such as zip code indicating the location. The data from peer listing may include vertical market data obtained from curators, publishers etc. Additional factors may include data from weather, sport seasons, reviews, social graph, sales, sport growth, etc. Upon receiving the request to estimate the value of the item, the pricing engine may obtain data such as location, quality, social graph, weather, season, and peer listings which may include listings from one or more vertical market places. Upon obtaining the data, the pricing engine may determine current value of the item and/or track the value of the item over a period of time based on the aforementioned factors. Using the wide array of factors to determine a used item's value enables a value of the item to be accurately determined in a new and unconventional way.

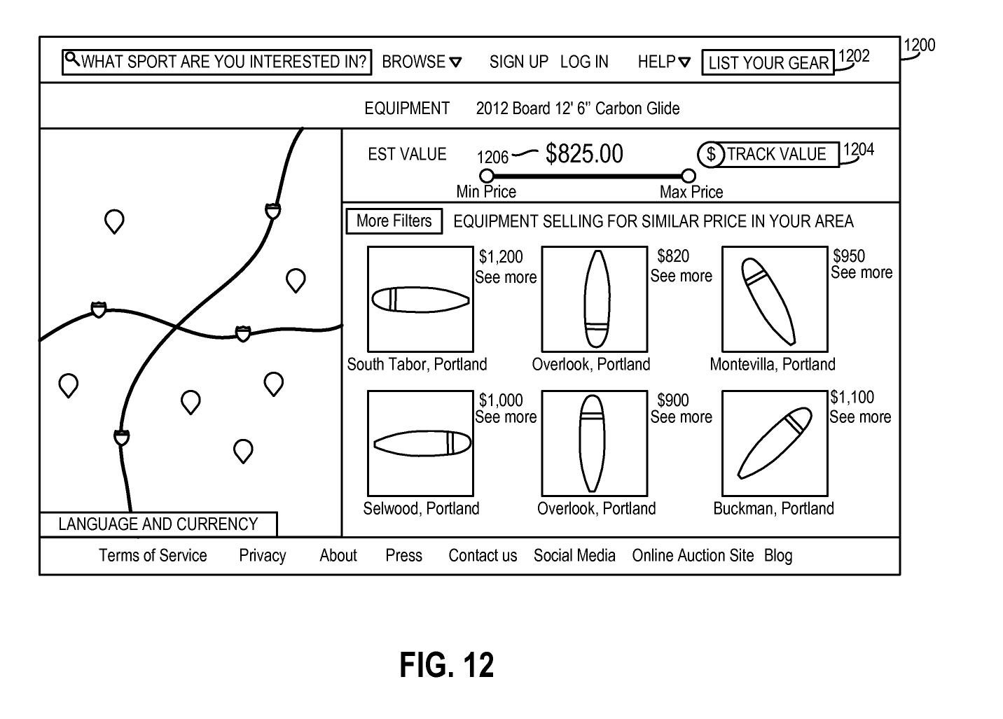

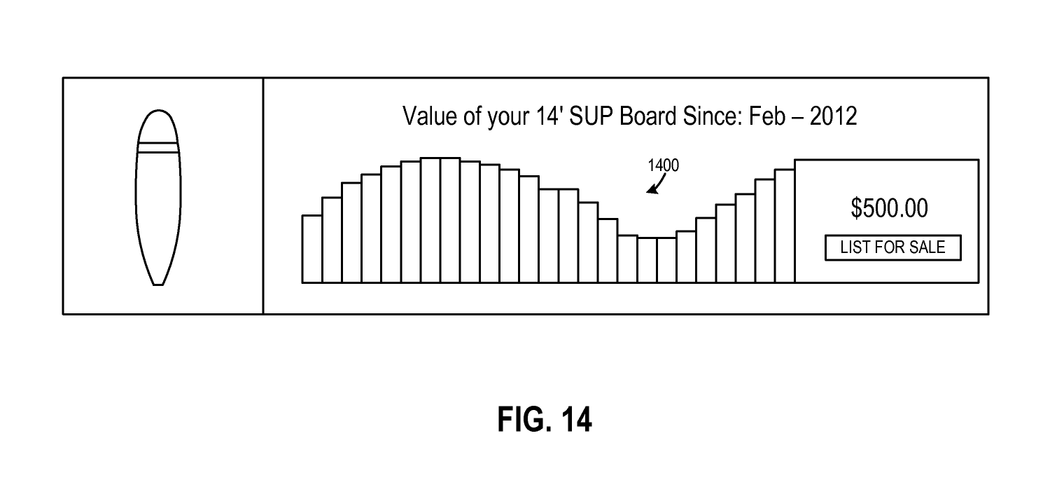

Upon determining the value of the item, the pricing engine may deliver a price response (at 310) as output. Additionally or alternatively, the pricing engine may deliver a product value tracking response (at 312) providing product value over a period of time as output. An example price response output indicating the value of the item queried is shown at FIG. 12. An example price tracker response output indicating the value of the item queried over a period of time is shown at FIG. 14.

A single “estimate value” button (indicated at 318) may be provided at the web interface for the user to obtain the value of one or more items. Additionally, a single “track value” button (indicated at 320) may be provided for the user to obtain the value of one or more items over a period of time. The items may be registered by the user in the garage system. For example, the user may view a list of items registered by the user in a register of the online garage system and may click the “estimate value” or “track value” button provided for each item to estimate value of the item or obtain the value of the item. In other words, through a single click (or single action) of the “estimate value” button, the user may obtain an estimate of the value of the item, and similarly, in some embodiments, through a single click (or a single action) of the “track value” button, the user may track the value of the item over a period of time (that is, over the useful life of the item). In one example, the “estimate value” button or the “track value” button may be utilized to track the value of all the items in the user's register. In another example, the user may select a number of items and click the “estimate value” button or the “track value” button to obtain the values for the number of selected items. It should be appreciated that button, as used herein, may be any suitable request mechanism with any suitable interface (e.g., graphical user interface). The buttons are not limited to the example disclosure provided herein.

Additionally, or alternatively, the item may be a result of a search query requested by the user. Upon obtaining the search results, through a single click (or single action) of the “estimate value” button, the user may obtain an estimate of the value of the item, and similarly, in some embodiments, through a single click (or a single action) of the “track value” button, the user may track the value of the item over a period of time (e.g., over the useful life of the item). As an example, the user may search for a used mountain bike that is available for sale at a specific geographical location through the online garage system. The pricing engine may identify all the mountain bikes in the specified location listed by sellers who may be users of the online garage system. Upon obtaining the search results, the user may click the “estimate value” button or the “track value” button provided for each search result to obtain the value of a particular mountain bike. In one example the “estimate value” button or the “track value” button may be utilized to track the value of all the items from the search. In another example, the user may select a number of items from the search result and click the “estimate value” button or the “track value” button to obtain the values for the number of selected items.

In one example, in addition to clicking the “track value” button, the user may provide an additional input such as a time period for which the pricing engine may determine the value. In the absence of the additional time period input from the user, the pricing engine may determine the value of the item over a predetermined period of time. In another example, the pricing engine may determine value of the item over its life cycle.

FIG. 4 shows a process flow 400 for determining the value of items in the online garage. A price query 410 for the value of an item may originate from a device such as a mobile device, a tablet, or a personal computer. For example, a user may utilize one of the devices to open a browser. Subsequently, the user may log into the online garage system via the internet or other suitable network and place the price query 410 to determine a value for an item of interest. In one example, the user may be a retailer. The query may be transmitted to the garage server where the pricing engine may collect information and estimate a value for the queried item. The pricing engine may receive pricing information from one or more online e-commerce businesses such as eBay, Amazon etc. by communicating with the respective servers via API. Additionally the pricing engine may receive review information from blog feeds. The pricing engine may also utilize a web crawler to update an index in order to improve the speed of searching. As shown at FIG. 5 the pricing engine may organize and catalog product, and pricing information by interacting with API of businesses that offer online shopping, and blog feeds, and by utilizing web crawlers. Product information may include UPC/QR codes and brand SKUs.

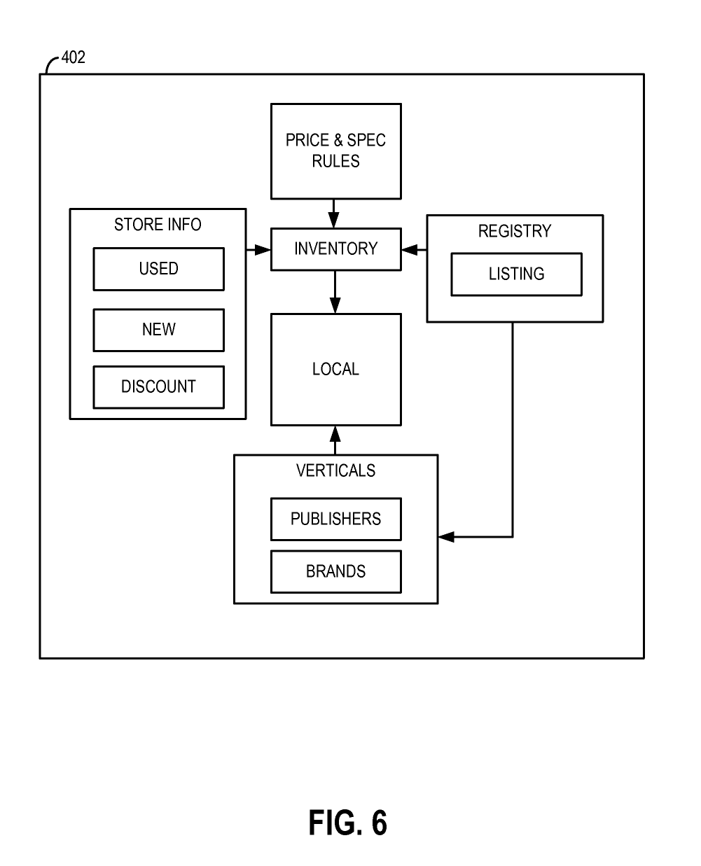

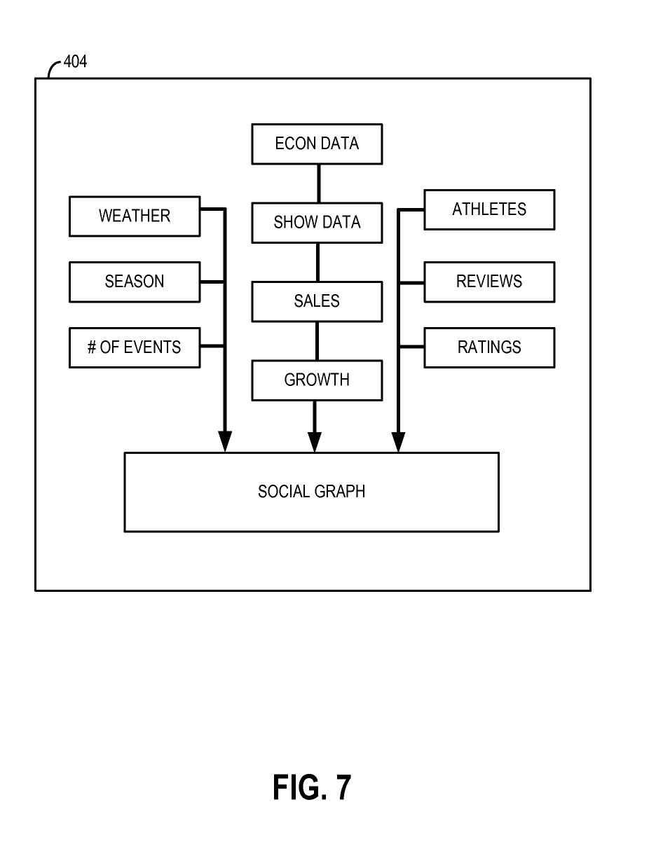

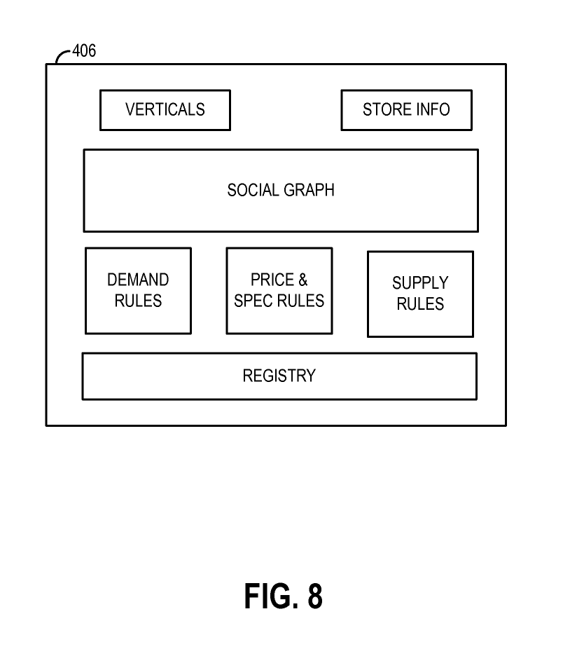

The pricing engine 64 includes a first module 401, a second module 402, a third module 404, and a pricing algorithm 406. The first module 401 is shown in greater detail in FIG. 5. The second module 402 is shown in greater detail in FIG. 6. The third module 404 is shown in greater detail in FIG. 7. The structure of the pricing algorithm 406 is shown in greater detail in FIG. 8.

The pricing engine may also collect inventory information of the product (that is, the queried item) as shown in the second module 402 depicted in FIG. 6. The inventory information may include a condition of the product. For example, the product may be used or new. If the product has been used, it may be determined if the product condition is one of excellent, very good, or good. The inventory information may be based on the date of purchase, purchase cost, insurance, warranty, and duration of warranty for example. Additionally, information of the product from vertical market such as publishers, curators, and brands may also be considered in estimation of its value. Additionally, store info 412 such as used item information, new item information, and/or discounted information, may be used to determine inventory information. Registry information 414, such as product listings, may also be used to determine inventory and social information. The inventory information may be gathered from servers such as the servers (76, 78, and 80) shown in FIG. 1. Verticals 416, such as publisher and brand information, may also be used to determine inventory and/or social information.

The changing global marketplace results in a continually changing reality in regards to pricing due to the changing economic environment and the ever-increasing adoption of new technologies. Brand perception and consumer shopping behavior may change such that the publisher and brand information adapts to the value perceptions. Such continual changes result in real time differences as to resale value of a product. Each of the various parameters may be adjusted to the real-time environment to determine the resale value.

As a further example, the pricing engine may collect social information as shown in the third module 404 in FIG. 7. The social information may be based on weather, sporting seasons, reviews, ratings, percentage of sales, popularity etc. For example, a queried item such as a surf board may be priced differently at a location where surfing is a popular sport compared to a location where surfing is not common. Upon collecting information from various sources as discussed above, the pricing engine may determine the value of the queried item. Taken together, the pricing engine may store product information, and determine value of the item based on based on pricing and product information, inventory information, and social information as shown in the pricing algorithm module 406 shown in the pricing algorithm module 406 shown in FIG. 8. As such, the algorithmic pricing engine may be connected to a registry and one or more bi-lateral marketplaces. It will be appreciated that the information gathered via the pricing engine shown in FIG. 4 can be used to generate factors used in the pricing algorithm to determine used product pricing.

As shown in FIG. 4 the pricing engine 64 can generate an instant price answer 418 in response to receiving the price query 410. It will be appreciated that the instant price answer may be a transition price for a used item.

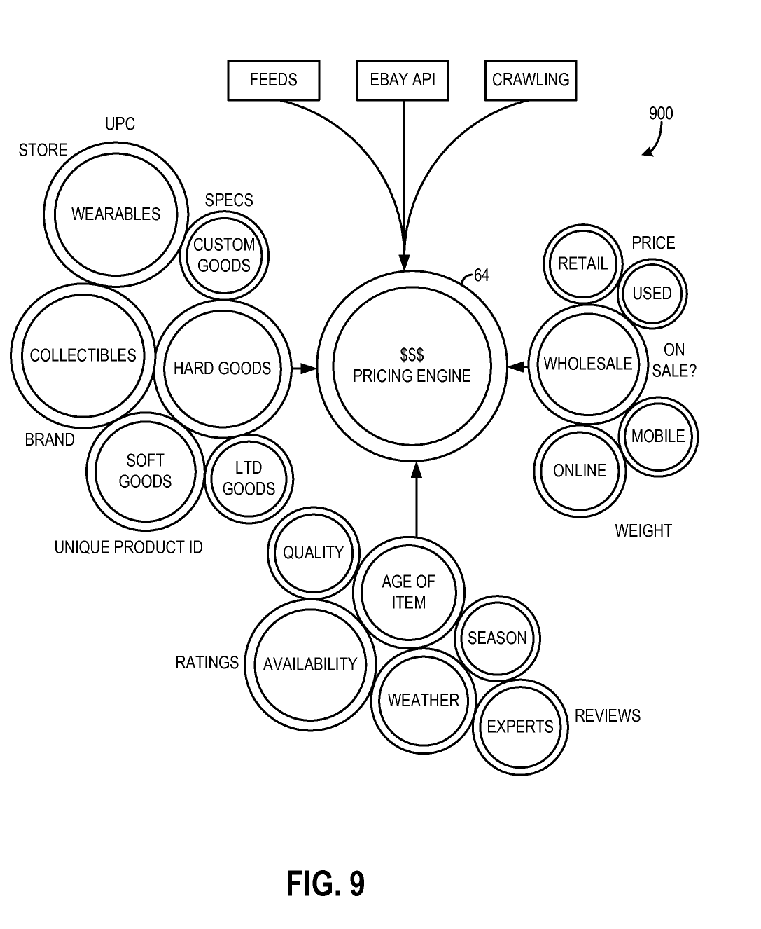

FIG. 9 schematically shows an interactive process flow 900 of various factors or parameters involved in estimating value of items utilizing the pricing engine 64. A pricing engine user may utilize the pricing engine 64 to enquire value of one or more items in the user's online garage. The user's online garage may include items from a single niche market such as outdoor sporting goods, baby products, home furniture, or products for photography, for example. Alternatively, online garage may include a variety of items such as wearables, collectibles, soft goods, limited goods, custom goods etc. In order to estimate the value of the queried product, the pricing engine may receive input from one or more online e-commerce business databases regarding product information such as UPC/QR code, brand SKUs and other information specific to the product. In this way, identifiers associated with the product/item can be ascertained which enables additional product information to be quickly gathered to enable an accurate used price determination.

The pricing engine may also receive input from various blog feeds regarding reviews and ratings for the product, seasonal popularity of the product, etc. The seasonal popularity may be based on sports season (when the product is a sporting good) and/or weather conditions. Additionally, information regarding condition of the product, age of the product, sale, etc. may be used as input to the pricing engine. Further, the pricing engine may utilize a web crawler to update a web index for the engine. In this way, the pricing engine may estimate the value of one or more products in the user's online garage not only based on product information and price but also accounts for social and climatic factors. For instance, weather events may be taken into account when determining a transition price of a used item.

In some examples, the parameters may be weighted in regards to determining pricing based on the amount of change from a standard or previous value assignment. Thus, a seasonal change may affect pricing to a higher extent than an incremental change in age of a product which has passed a threshold age transition period. In other examples, the factors or parameters may be averaged. In even other examples, a change in a select combination of parameters may trigger a price adjustment. In some examples, a geographic location may be used in combination with at least one market factor, such as a specification factor, an available inventory factor and/or a social trend factor to determine a transition price. In an illustrative example, and not as a limitation, the geographic location factor may determine a base or average price for the used item based on comparative sales of the item in the geographic location. The base or average price may be adjusted based on a specification factor, an available inventory factor and/or a social trend factor. The adjustment may be based on a change or difference in each factor from a pre-selected time-frame resulting in an increase or decrease from the base price.

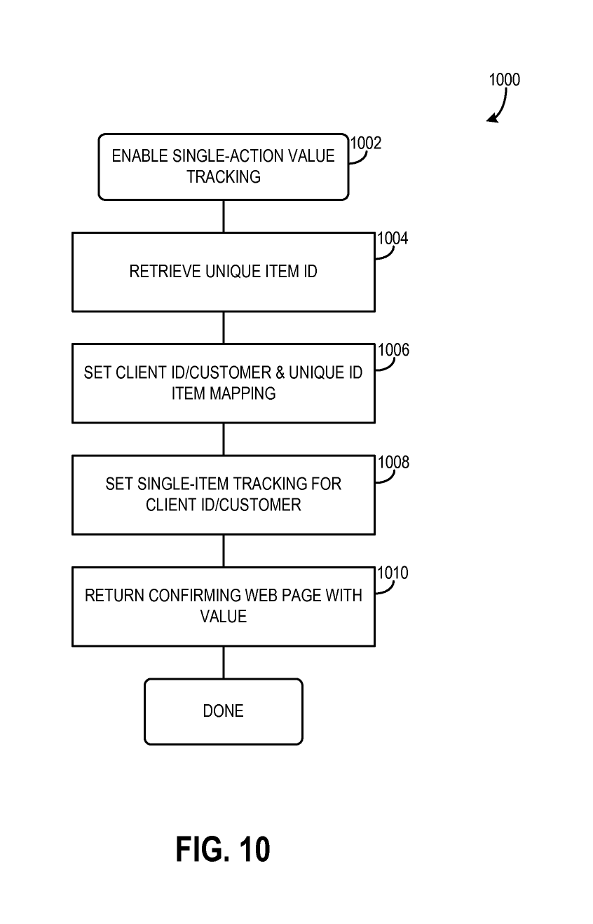

FIG. 10 shows an example method 1000 for tracking the value of an item in the online garage. The user may track the value of the item by clicking a single button in the online garage at a client computing device. The button may be a “track value” button. The request for tracking value may be received by a server system. Therefore, at 1002 single-action value tracking is enabled. That is to say the clicking a single button such as the “track value” button can solely initiate value tracking of a desired item. In this way, an items value can be quickly tracked via a user.

In addition to the request, the server may receive data including identification of the purchaser, product information, and various feeds. Therefore, at 1004 the method includes retrieving a unique item identifier. The unique item identifier may be a product code, bar code, SKU, etc.

Next, the server may assign a client identifier to the client's item and associate the assigned client identifier with the received purchaser information. Thus, at 1006 the method includes setting client id/customer & unique id item mapping. The server system may then send the assigned client identifier to the client computing device. The server may also send a HTML document identifying the item including a track value button. The client computing device may receive, track value and store the assigned client identifier. Therefore, at 1008 the method includes setting single-item tracking for client id/customer.

Further, the client may receive and display the HTML document. In response to the selection of the track value button, the client computing device may send a request to the server system to obtain current and historical data to track the value of identified item. The server system may receive the request and combine the purchaser information associated with the client identifier of the client computing device to generate an order to track the value of the item in accordance with the data and valuation engine, whereby the client or purchaser is apprised of the value of the product upon selection of the track value button. Thus, at 1010 the method includes returning confirming web page with value.

In other words, the pricing engine may receive user information, record the information, and send a cookie containing a user number to the browser to identify the user and assign the user number to an item owned by the user or to an item that the user tracks the value of. In this way, the pricing engine may facilitate the user to make better decisions about buying or selling the item. Subsequently, every time the user clicks on a page from the server, the browser sends back the cookie that the browser previously received from the server. This gives the server user information and attaches the items unique ID and corresponding current value. The user ID may be utilized to find user information.

As provided above, changes in value perception and economic environment are parameters to determine real-time value for resale. Further, in face of changes to the global marketplaces—significant weather, sports seasonality, etc., brands value may increase or decrease. Further, the popularity of a sport may impact supply and demand such that consumers change not only their shopping behaviors but also their value perceptions. In order to address the continuing marketplace perception and changes, the pricing engine determines a supply and demand relationship. For example, as the demand decreases over time (such as to change of season or other parameter or combination of parameters), a high quantity of product may result in a first price. A low quantity of product during the same demand period may result in a second price higher than the first price. Similarly, as the supply of product increase, a first price may be established if there is a first quantity level. A second price (different than the first price) may be established based on a difference in quantity level. As the supply and demand change, the price may similarly change as the quantity levels change.

As such, the pricing engine provides for a method to track and monitor the environment to identify marketplace changes, both expected and unexpected. The system, in some embodiments, provides a method for a user (such as tracking a product SKU) to (1) identify value of a product (e.g. their sports gear), (2) identify and take advantage of opportunities created by increase in demand, and (3) optimize value of gear they own based on the supply demand relationship. Technological changes, such as social media and mobile retail sales, affect both the benefit side (e.g., instant access to product information, such as reviews) and the cost side (e.g., lower search costs, lower prices) of the value equation such that the pricing engine is constantly adjusting the price as parameters change.

Turning again back to the pricing engine, the parameters and combination of parameters are considered to establish pricing. Changes in one or more of the parameters may result in a change to the resale price. For example, particular periods or dates (such as Black Friday) or a seasonal period (winter) may result in a change to the resale price. Geographic location may also affect resale value as may brand value changes in resulting from social media. For example, social networks such as Facebook may share product reviews. As another example, price promotions from online retailers or other retailers may also change the supply/demand relationship and result in a new pricing.

The pricing engine utilizes these parameters to adjust the supply demand curve to determine a resale value. The pricing continues to evolve as a function of the changes in consumer behavior that are driven by both economic and technological shifts.

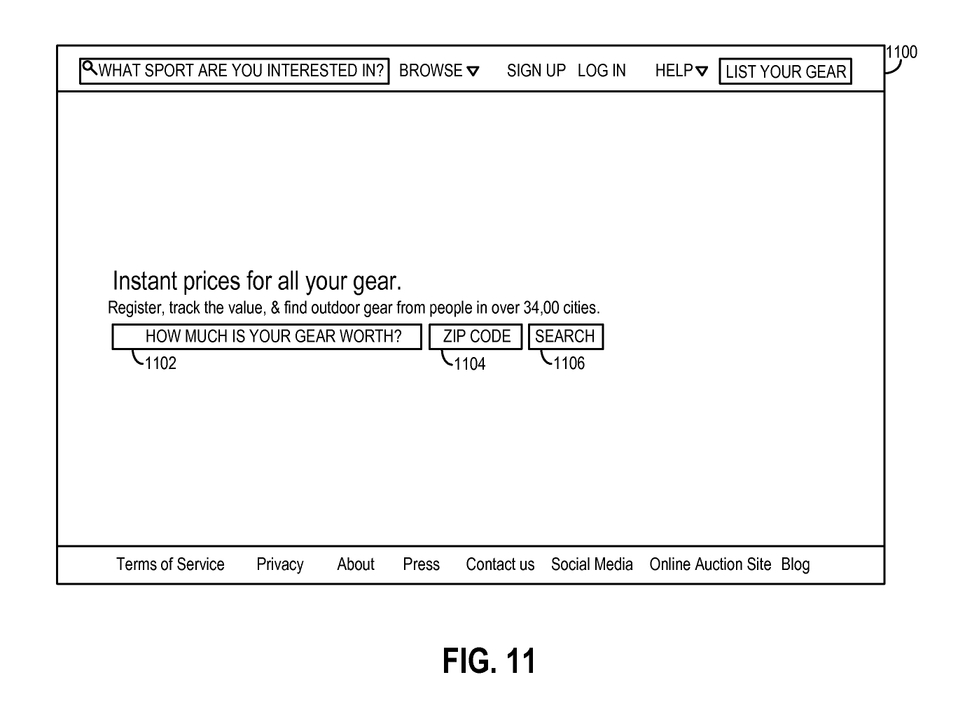

FIG. 11 shows an example graphical user interface 1100 of a search page of the online garage system. In this example, the online garage system may be a system configured to track the value of sporting gear including indoor and outdoor sporting gear. In another example, the online garage system may be utilized to track value of any item that may have re-sale value, trade-in value, and/or donation value. For example, a user may utilize the online garage to sell baby products, electronic items, home furniture, garden equipment, etc.

A user may register one or more items after purchase in the online garage system, estimate current value, and track the value of the registered items over a period of time through the search interface. As shown the graphical user interface 1100 include a field 1102 enabling a user to enter product information, a field 1104 enabling a user to enter a geographical location (e.g., zip code) associated with the item, and a button 1106 enabling a user to search for a requested item.

It will be appreciated that the online garage system may be used to estimate the value of the item based on location. Upon entering a query, the garage system may utilize the pricing engine, such as the pricing engine 64 shown in FIG. 1, to determine the value of the queried item and respond with a price response as shown at FIG. 12.

FIG. 12 shows a graphical user interface 1200. In the illustrated example at FIG. 12, the user may obtain value of an outdoor sporting item such as a 2012 board 12′ 6″ carbon glide. Upon clicking an estimate value button, the pricing engine may estimate the value of the item and display the estimated market transition value (1206) of the queried item. Further, the pricing engine may search the WWW to determine the value of similar equipment listed for sale in the same geographic area (e.g., state, zip code, city, neighborhood, etc.,) and display the results through the garage interface. In this way, a user is provided with comparable used items for sale in their geographical region.

Still further, the user may list one or more items for sale through the online garage system. In the illustrated example at FIG. 12, by clicking the “list your gear” button (1202), the user may list the item for sale. Additionally, through the online garage system, the user may list one or more items automatically for sale in one or more e-commerce business sites such as eBay, craigslist etc. For example, with the item information already stored in the garage system the user may be able to list the item for sale in one or more websites by simply clicking the “list item for sale” button. In one example, the listings may be posted in vertical market places that locally connect buyers and sellers. Further, an option for social share may be built into each listing to help connect peers. The vertical markets may be curated by channels that build trust and community. In this way, listings may be posted in omni-channel marketplaces for ease of listing and sharing. The marketplaces may be set-up such that shops, brands or individuals listing more than one item may have their own store. Each listing may be its own searchable website with a mobile wallet and may be connected to social channels such as social networking sites and mobile applications and websites which offer visual discovery, collection, sharing, and storage tools.

In addition to obtaining the value of the queried item, the user may track the value of the item over a period of time by clicking (in other words, selecting) a single “track value” button (1204). In other words, through a single click, the user may track the value of the item. An example output obtained after clicking the “track value” button is shown at FIG. 14.

Further, the garage system may provide recommendations to the user regarding newer models of the queried item and pricing for the newer models from one or more e-commerce business sources, publishers, and/or curators. For example, based on the query for value of 2012 board 12′ 6″ carbon glide, the garage system may provide recommendations and pricing information for a newer model such as a 2013 board 12′ 6″ carbon glide.

Still further, by utilizing the garage system, the user may search for the value of the item at different geographic locations by moving a map in the garage interface to a desired geographic location or by receiving input of another geographical area through an input field.

In this way, the pricing engine may track the value and location of an item over its lifecycle keeping users (e.g., consumers) appraised of the re-sale value of the items they own, and seamlessly post items for re-sale when the owner is ready.

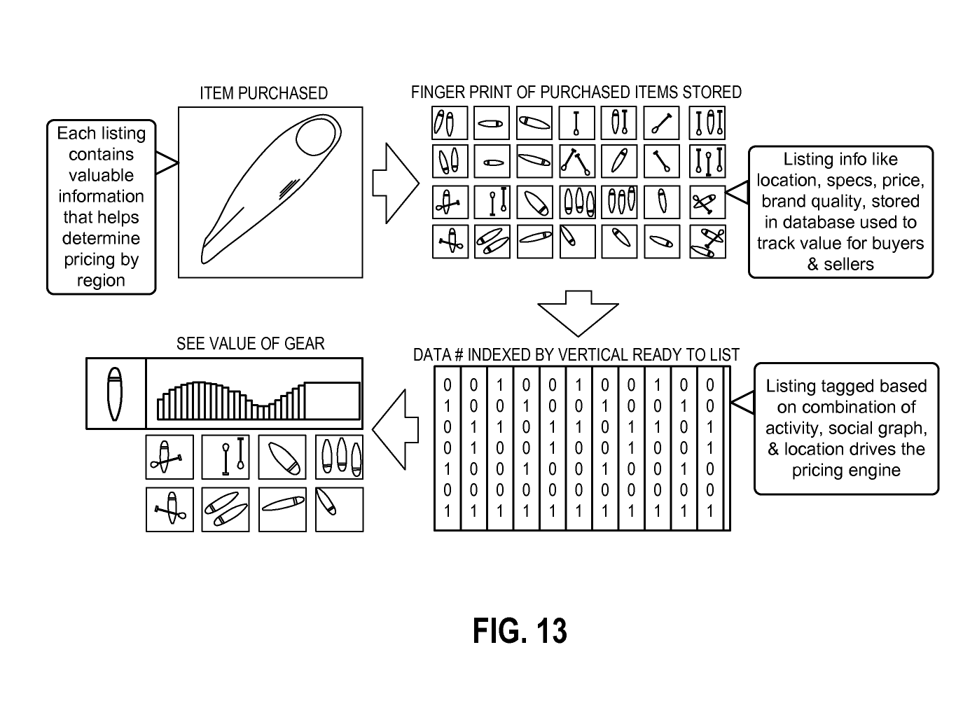

Information of the listings such as location, photograph, specifications, price, brand, quality etc., may be stored in the garage database and may be used to track value for potential buyers and sellers as shown at FIG. 13. The listings may be tagged based on combination of activity, social graph and location. Listings from vertical market such as curators, publishers, and brands may be taken into consideration in estimation of value of the item for added accuracy.

Additionally, the garage system may utilize the pricing engine to determine the value of the item over a period of time and display the product value for the period of time as shown at FIG. 14. FIG. 14 shows a plot 1400 of an item's value over time. As shown, the plot 1400 is non-linear. Additionally, the plot 1400 is a bar chart. However, in other examples the pricing plot may be represented via a continuous graph or via discrete point values. It will be appreciated that the plot 1400 may be generated via the pricing engine using the various factors described above. The plot 1400 enables a user to see how the value of a used item changes over the lifecycle of the item. As a result, the user can make a more informed decision about selling the item, insuring the item, etc.

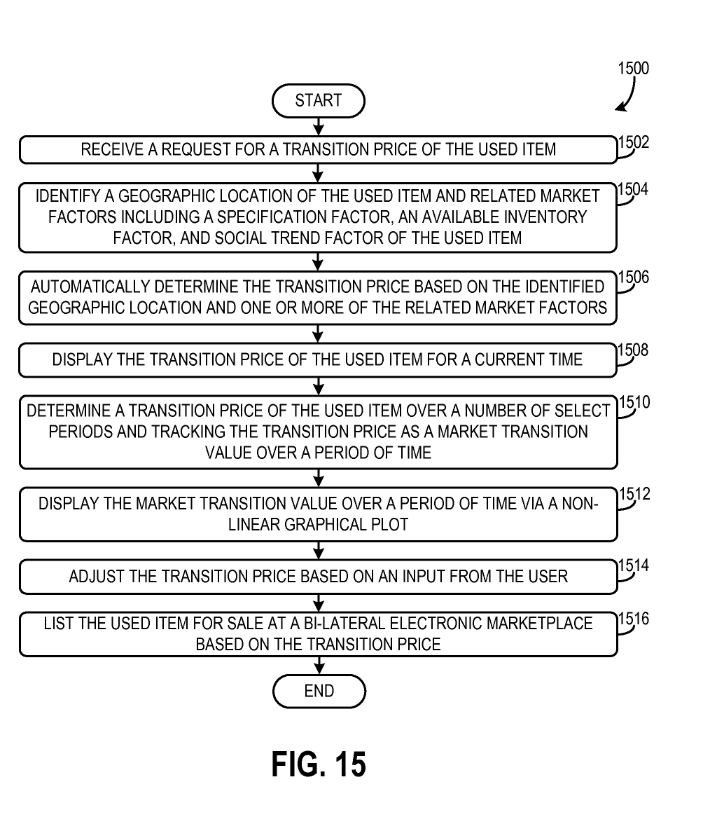

FIG. 15 shows a method 1500 for automatically pricing a used item. The method 1500 may be implemented via the online garage system discussed above with regard to FIGS. 1-14 or may be implemented via another suitable online garage system.

At 1502 the method includes receiving a request for a transition price of the used item. In one example, the request may be generated by a client computing device and sent to a pricing engine executed on a garage server. Specifically, in one example the request for a transition price of the used item is generated in direct response to a single action performed through interaction with a graphical user interface to request the transition price. In this way, only a single action may be performed to initiate generation of a transition price. As a result, a user can be quickly provided with a transition price with a small of amount of user input. Additionally in one example, the used item may be part of an item library including of a plurality of used items. The method may also include receiving a request for tracking the market transition price of the used item prior to step 1504, in one example.

Next at 1504 the method includes identifying a geographic location of the used item and related market factors including a specification factor, an available inventory factor, and social trend factor of the used item. For example, a social trend factor may identify a number of positive reviews for a specific item in a select period. In other examples, the number of negative reviews may be determined. Further, in some embodiments, the change in the number of reviews over a period may be determined as the social trend factor. Such a factor can then be weighted or averaged with the other factors to determine a transition price.

The geographical location of the used item may be gathered via user input received by the client computing device or inferred from a location of the client computing device. Additionally, the related market factors may be determined based on data received from a plurality of electronic commerce retailers, in one example. Further in one example, the specification factor may include a UPC, a QR code, and/or a brand SKU. In yet another example, the available inventory factor may include a condition of the used item, a date of purchase of the used item, and a purchase cost of the used item. In another example, the social trend factor may include reviews of the used item. For instance, reviews may be gathered over the Internet via blogs or other sites that provide product reviews.

At 1506 the method includes automatically determining the transition price based on the identified geographic location and one or more of the related market factors. In one example, all of the related market factors may be used to determine the transition price. It will be appreciated that the pricing engine discussed above may be used to automatically determine the transition price of the used item. In one example, the transition price may be also automatically determined based on a climatic factor. For instance, inclement weather such as hurricanes, floods, winter storms, etc., can affect a used item's value. Seasonal precipitation (e.g., rainfall and snowfall) can also affect a used item's value. For example, the price of used skis, snowboards, etc., may be increased during a winter with above average snowfalls due to the increased demand for skis and snowboards.

Next at 1508 the method may include displaying the transition price of the used item for a current time. It will be appreciated that the transition price can be presented on a display of the client computing device.

At 1510 the method includes determining a transition price of the used item over a number of select periods and tracking the transition price as a market transition value over a period of time. Therefore, it will be appreciated that the market transition value may include a plurality of transition prices, in one example. Additionally in one example, the select periods may be pre-selected by the user. Determining the market transition price enables a user to view value adjustment over selected time periods, giving them a more complete picture of the item's value lifecycle.

At 1512 the method includes displaying the market transition value over a period of time via a non-linear graphical plot. Thus, in one example step 1512 may include displaying the market transition value for the plurality of time points for the used item.

Next at 1514 the method includes adjusting the transition price based on an input from the user. In this way, a user can change the transition price based on data gathered from additional sources, which may be useful when a user is intending to sell the used item. It will be appreciated that input from a user may be generated via a user's interaction with a graphical user interface presented via the client computing device.

At 1516 the method includes listing the used item for sale at a bi-lateral electronic marketplace based on the transition price. In this way, a user can quickly and seamlessly place a used item for sale once the transition price has been determined via a pricing engine. As a result, a user can efficiently sell an item through the online garage system.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for automatically pricing a used item, comprising:
receiving a request for a transition price of the used item;
identifying a geographic location of the used item and related market factors including a specification factor, an available inventory factor, and social trend factor of the used item;
automatically determining the transition price based on the identified geographic location and one or more of the related market factors; and
displaying the transition price of the used item for a current time.

2. The method of claim 1, where the used item is part of an item library including of a plurality of used items.

3. The method of claim 2, further comprising determining a transition price of the used item over a number of select periods and tracking the transition price as a market transition value over a period of time.

4. The method of claim 3, where the select periods are pre-selected by the user.

5. The method of claim 3, further comprising displaying the market transition value over a period of time via a non-linear graphical plot.

6. The method of claim 1, where the related market factors are determined based on data received from a plurality of electronic commerce retailers.

7. The method of claim 1, where the specification factor includes one or more of a universal product code (UPC), a quick response (QR) code, and a brand stock keeping unit (SKU).

8. The method of claim 1, where the available inventory factor includes a condition of the used item, a date of purchase of the used item, and a purchase cost of the used item.

9. The method of claim 1, where the social trend factor includes reviews of the used item.

10. The method of claim 1, where the transition price is also automatically determined based on a climatic factor.

11. The method of claim 1, further comprising listing the used item for sale at a bi-lateral electronic marketplace based on the transition price.

12. The method of claim 1, further comprising adjusting the transition price based on an input from the user.

13. The method of claim 1, where the request for a transition price of the used item is generated in direct response to a single action performed through interaction with a graphical user interface to request the transition price.

14. A method for tracking a market transition value of a used item, comprising:
receiving a request for tracking the market transition value of the used item;
determining a market transition value of the used item at a plurality of time points over a period of time, the market transition value based on related market factors including a specification factor, an available inventory factor, a social trend factor, and a climatic factor of the used item; and
displaying the market transition value for the plurality of time points for the used item.

15. The method of claim 14, where the used item is part of an item library including a plurality of used items generated based on a base product input from a user.

16. The method of claim 15, where the base product input includes at least one of a purchase value of the used items, a time of purchase, a purchase location and a payment information of the purchase of the used item.

17. The method of claim 15, further comprising receiving updated product input from the user for the used item prior to determining the market transition value and where the market factors are based on the base product input and the updated product input.

18. The method of claim 15, where the market factors are based on the base product input.

19. A system for generating a market transition value of a used item, comprising:
a client computing device configured to provide an interface for a user to input purchase information of an item, and request a value for the item;
a garage server connected to the client computing device over a network and configured to;
receive the input purchase information and process the input purchase information;
automatically track a market transition value of the item over time based on a geographical location of the used item and market factors including one or more of a specification factor, an available inventory factor, and a social trend factor of the used item;
determine a transition price of the item based on the market transition value; and
send an output including the transition price and the market transition value over time to the client computing device; and
a database configured to store information regarding the user, the used item, the transition price, and the market transition value of the item.

20. The system of claim 19, where the request for the value of the item is initiated by only a single action in the interface.
